(19) United States
(12) Patent Application Publication
(10) Pub. No.: US 2009/0109810 A1
(43) Pub. Date: Apr. 30, 2009

(54) RECORDING/REPRODUCTION APPARATUS

(76) Inventors: Masayuki Fukuyama, Osaka (JP); Eiji Miyagoshi, Osaka (JP); Akihiro Watabe, Nara (JP); Akihiko Otani, Osaka (JP); Noboru Mizuguchi, Osaka (JP); Yuichiro Aihara, Osaka (JP)

Correspondence Address: MCDERMOTT WILL & EMERY LLP, 600 13TH STREET, NW, WASHINGTON, DC, 20005-3096, US

(21) Appl. No.: 12/203,418

(22) Filed: Sep. 3, 2008

(30) Foreign Application Priority Data
Oct. 31, 2007 (JP) 2007-283154

(51) Int. Cl. G11B 7/00

(52) U.S. Cl. 369/44.27; G9B/7

(57) ABSTRACT

A recording/reproduction apparatus includes a first recording medium (a flash memory) having a first time that is required for the first recording medium to go from a low-power consumption state to a state in which recorded video data can be read out, and a second recording medium (an HDD or a DVD drive) having a second time that is required for the second recording medium to go from a low-power consumption state to a state in which recorded video data can be read out, where the second time is longer than the first time. When a video content is reproduced from the second recording medium in the low-power consumption state, the first recording medium is caused to go to a readable state while the second recording medium is not in a readable state, and a leading portion of the content is reproduced from the first recording medium. Thereby, a start-up time of the second recording medium that is required until reproduction is permitted is concealed from the user, and the user's reproduction request is immediately responded.

### BACKGROUND OF THE INVENTION

1. Field of the Invention

The present invention relates to a recording/reproduction apparatus having two or more recording media that have different start-up times that it takes for the media to get ready for data access.

2. Description of the Related Art

According to a certain conventional technique, a hard disk drive (HDD) and an optical disc drive are used in combination to record video contents. Specifically, whole content data is recorded on an optical disc, and file information containing a leading portion thereof is recorded in the HDD. When there is a reproduction request, reproduction is first started using data in the HDD, and then, while the remaining data is read out from the optical disc and is transferred and recorded into the HDD, the data is successively reproduced from the HDD. In other words, a cache technique of increasing access speed is employed where the optical disc drive serves as a low-speed device and the HDD serves as a high-speed device. If a cache error occurs, an operation of transferring data from the low-speed device to the high-speed device is performed, so that direct access is mainly performed with respect to the high-speed device (Japanese Unexamined Patent Application Publication No. 2001-014110).

### SUMMARY OF THE INVENTION

In recent years, as the capacities of recording media, such as a hard disk and the like, have been increased, the start-up time of the recording medium that is required from turning on of a power supply until data can be read out has become longer, so that it disadvantageously takes a significantly long time to start reproduction.

Also, large-capacity recording media have large power consumption. Therefore, when these recording media are not accessed, the media are preferably caused to be in a low-power mode that can suppress power consumption. However, in the conventional art, it takes a long time to go form the low-power mode to a normal state in which data can be read out. Therefore, low power consumption and high access speed cannot be simultaneously achieved.

The present invention has been achieved to solve the above-described conventional problems. An object of the present invention is to provide a recording/reproduction apparatus having a system configuration that can reduce the time required until the start of reproduction.

To achieve the object, a recording/reproduction apparatus according to an aspect of the present invention includes a first recording medium having a first time that is required for the first recording medium to go from a low-power consumption state to a state in which recorded video data can be read out, a second recording medium having a second time that is required for the second recording medium to go from a low-power consumption state to a state in which recorded video data can be read out, where the second time is longer than the first time, and a reproduction control section for controlling the first and second recording media so that a recorded video content is reproduced. A video content is first reproduced from the first recording medium that can quickly go to the readable state, and next, after the second recording medium goes to the readable state, a continuation of the content is reproduced from the second recording medium.

According to the present invention, a drawback of a recording medium that has a large capacity and for which it takes a long time to go from a low-power consumption state to an accessible state can be compensated for, so that a time from when a reproduction request is issued to when reproduction is started can be reduced. In other words, a time that is required until reproduction is started can be reduced, resulting in a quick reproduction start-up.

### BRIEF DESCRIPTION OF THE DRAWINGS

FIG. 1 is a block diagram schematically showing an exemplary configuration of a recording/reproduction apparatus according to an embodiment of the present invention.

FIG. 2 is a flowchart showing a reproduction operation of the recording/reproduction apparatus of FIG. 1.

FIG. 3 is a conceptual diagram showing a switching operation of recording media in the recording/reproduction apparatus of FIG. 1.

FIG. 4 is a time chart showing a reproduction sequence of the recording/reproduction apparatus of FIG. 1.

FIG. 5 is a flowchart showing a reproduction interruption operation of the recording/reproduction apparatus of FIG. 1.

FIG. 6 is a flowchart showing a reproduction restart operation of the recording/reproduction apparatus of FIG. 1.

### DETAILED DESCRIPTION OF THE PREFERRED EMBODIMENTS

Hereinafter, a recording/reproduction apparatus according to an embodiment of the present invention will be described with reference to the accompanying drawings.

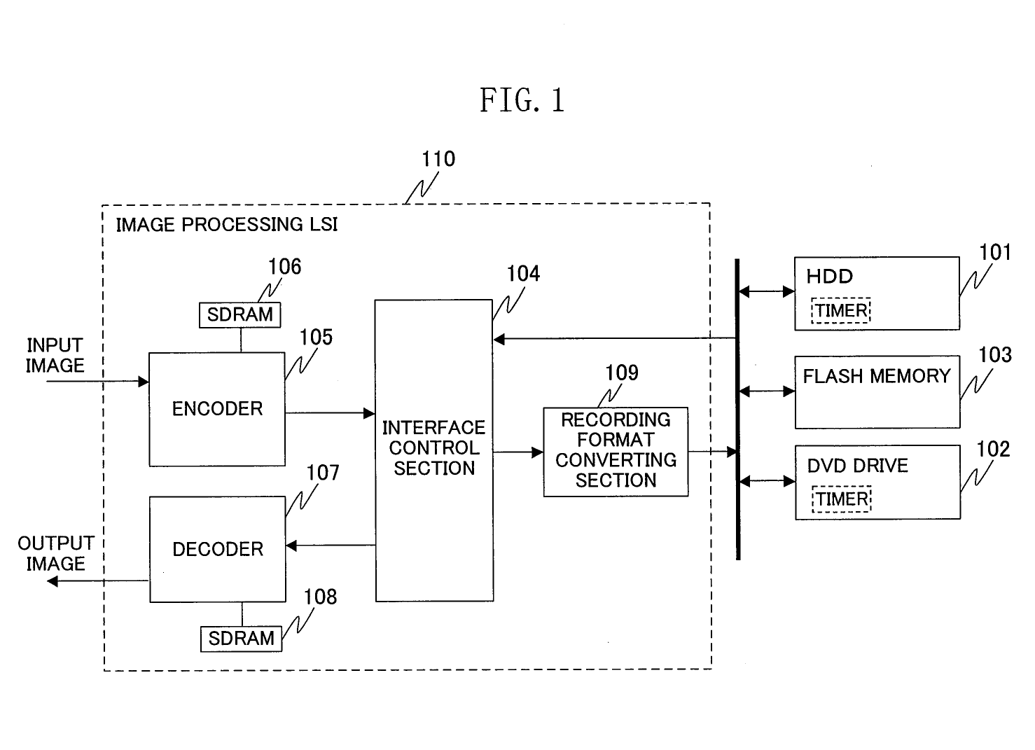

FIG. 1 schematically shows a configuration of the recording/reproduction apparatus of the embodiment of the present invention. The recording/reproduction apparatus comprises an HDD 101, a DVD drive 102, a flash memory 103, and an image processing LSI 110. The image processing LSI 110 comprises an interface control section 104 for controlling an interface between a recording medium and an image processing LSI, an encoder 105, an encoder SDRAM 106 that is used in an encoding process by the encoder 105, a decoder 107, a decoder SDRAM 108 that is used in a decoding process by the decoder 107, and a recording format converting section 109 for converting one recording format to another.

The recording/reproduction apparatus encodes image data via the encoder 105, and writes the resultant data into the HDD 101, the flash memory 103 and the DVD drive 102. During reproduction, the recording/reproduction apparatus operates to decode a recorded content from the HDD 101, the flash memory 103 and the DVD drive 102.

A content is recorded into or reproduced from the HDD 101, the DVD drive 102 and the flash memory 103, which are recording media of the recording/reproduction apparatus. The interface control section 104 selects and transfers a content from these recording media to the image processing LSI 110. The encoder 105 encodes an input image. The decoder 107 decodes a content to be reproduced. The recording format converting section 109 removes information that is not required for reproduction from the flash memory 103 in the recording/reproduction apparatus so as to reduce the recording capacity.

Here, the HDD 101 and the DVD drive 102 typically have large power consumption, and therefore, are desirably caused to be in the low-power mode when they are not used. Note that it takes a long time for these recording media to get ready for use after the low-power mode.

Note that the HDD 101 and the DVD drive 102 are only for illustrative purposes. Instead of these devices, a network storage or the like for which it takes a long time to respond may be used without impairing an essential feature of the present invention, for example.

Specifically, for example, when the HDD 101 is a 1.8-inch HDD (120-GB capacity), the power consumption is about 1 W and the maximum start-up time is about 2 sec. When the HDD 101 is a 2.5-inch HDD (250-GB capacity), the power consumption is about 1.4 to 2.5 W and the maximum start-up time is about 3 sec. When the HDD 101 is a 3.5-inch HDD (1-TB capacity), the power consumption is about 10 W and the maximum start-up time is about 13 sec.

By contrast, the flash memory 103 has a considerably short time that is required until it can be accessed after being powered ON from the low-power mode. Although the flash memory 103 is herein assumed as such a device, any recording medium, such as an SSD (Solid State Drive) or the like, that has a short time that is required until it can be accessed may be employed.

An effect of the present invention is exhibited by combining a recording device having a quick response and a recording device having a slow response. It should be noted that the slow response has a meaning different from that of low access speed.

The HDD 101 has a higher data transfer rate and a larger capacity than those of the flash memory 103. When such memories are used, a cache technique is well known in which a memory having a high access speed is used to increase a total access speed. In the present invention, however, a memory having a high access speed is not necessarily used, and attention is paid to the start-up time of a recording medium. Also, of the two kinds of recording devices, one is dedicated to use in a certain limited situation.

In a typical cache technique, if a cache error occurs, a transfer operation to the high-speed device begins and direct access is mainly performed to the high-speed device. In the present invention, however, if no data exists, data is obtained from another device, and transfer does not need to be performed during a normal operation.

The recording/reproduction apparatus of this embodiment is significantly different from the conventional art in that the flash memory 103 is provided. The start-up time of the flash memory 103 is overwhelmingly shorter than that of the HDD 101.

When the HDD 101 or the DVD drive 102 is ready, reproduction is performed from the HDD 101 or the DVD drive 102 without using the flash memory 103. An operation of the HDD 101 after start-up is not particularly different from that in the conventional art and will not be described. A situation of the HDD 101 where reproduction is started from the low-power state and reproduction is subsequently stopped, will be described. In other words, the present invention is characterized by an operation when the HDD 101 or the DVD drive 102 is not ready for reading. Such an operation will be hereinafter described in detail.

Specifically, reading cannot be performed: (i) immediately after power is turned ON; (ii) in the low-power mode; or the like. In such a situation, no read operation can be performed until the HDD 101 is started up in conventional HDD recorders. In order to solve this problem, the HDD recorder of the present invention performs an operation as follows.

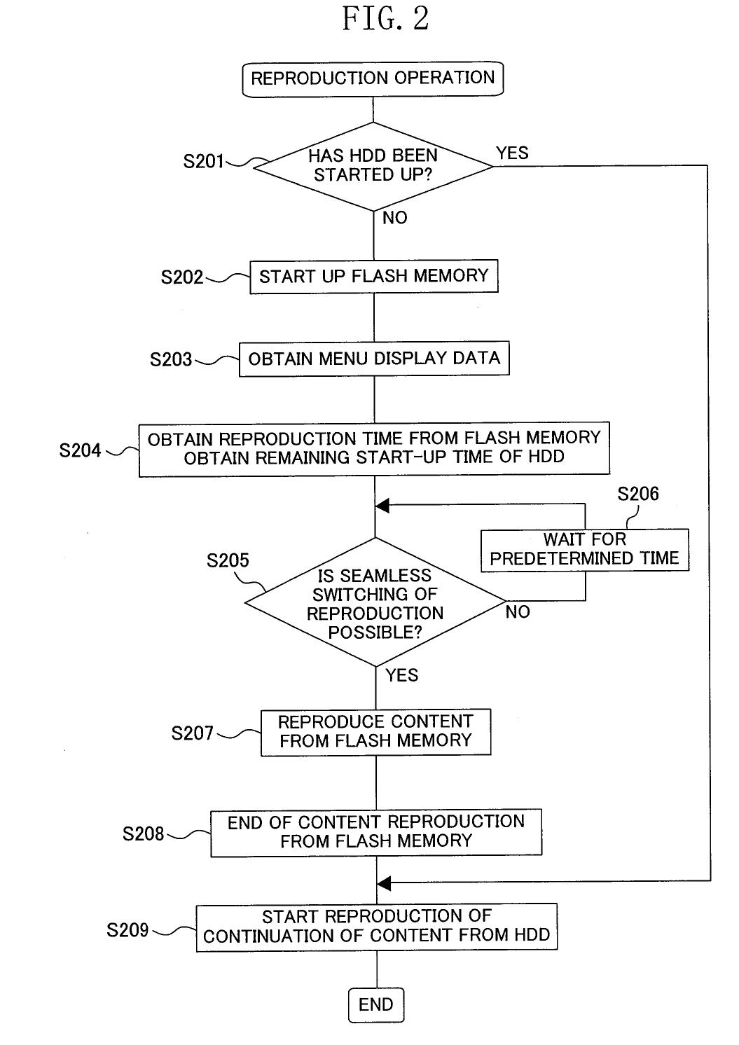

Hereinafter, a detailed operation will be described with reference to a flowchart shown in FIG. 2. Initially, it is examined whether or not the HDD 101 has been started up. If the HDD 101 has been started up, the HDD 101 is operated as in conventional HDD recorders (S201).

Next, the flash memory 103 is started up. This can be instantaneously achieved (S202). Initial menu display data is then obtained from the flash memory 103 and is provided to the user (S203). The displayed menu desirably mainly contains items composed of data recorded in the flash memory 103. Examples of the displayed menu include data that is highly frequently viewed, data that has been most recently recorded, and data that has been viewed immediately before. It is highly possible that these pieces of data are recorded in the flash memory 103. A procedure for writing data into the flash memory 103 will be described below. When no content data is contained in the flash memory 103, another screen may be prepared so that the user is not allowed to immediately perform selection. Note that not all menu items are necessarily written in the flash memory 103, a menu item that is considered to be less frequent may be read from the HDD 101. In any case, a menu that is first displayed can be obtained from the flash memory 103 immediately after the user issues a request, i.e., can be considerably quickly displayed.

Next, it is examined when a selected content can be reproduced from the flash memory 103 (time information) and how much longer a medium in which a continuation of the data is stored will get ready for reading (S204). Therefore, a content in the flash memory 103 is desirably recorded in association with the time information indicating when the content can be reproduced from the flash memory 103. It is also convenient if a timer indicating how much longer the start-up of the HDD 101 will be completed is included in the HDD 101 itself. If not, a worst-case time may be estimated. The HDD 101 of FIG. 1 includes a timer indicating the start-up remaining time.

Based on the result of calculation in step S204, it is examined whether or not, after a content is completely reproduced from the flash memory 103, a continuation of the content can be seamlessly reproduced from the HDD 101 (S205). If it is determined that seamless reproduction cannot be performed, the process waits for a particular time (S206). By repeatedly performing this, the process waits until a content can be seamlessly reproduced from the flash memory 103 and the HDD 101. Typically, an amount of content data corresponding to a time required to start up the HDD 101 is stored in the flash memory 103. Here, a large wait time does not occur. Note that an essential feature of steps S204 to S206 is that seamless reproduction can be achieved by appropriating switching media. The present invention is not necessarily limited to the above-described example.

Next, content data in the flash memory 103 is supplied to the decoder 107 and reproduction is performed (S207).

Thereafter, if the content data in the flash memory 103 is completely reproduced (S208), a continuation of the content data reproduced from the flash memory 103 is supplied from the HDD 101 to the decoder 107 based on the switching information obtained in step S204, and the continuation is reproduced (S209). By steps S205 and S206, it is guaranteed with high possibility that the HDD 101 is ready for reading when the content has been completely supplied from the flash memory 103.

As can be seen from the above-described flow, a whole content (e.g., a motion picture, etc.) does not need to be recorded in the flash memory 103, and it is sufficient that only a portion of the whole content corresponding to a worst-case time that is required until a medium containing the main portion of the content gets ready for reading, needs to be recorded therein. Therefore, the amount of content data stored in the flash memory 103 is not necessarily very large.

Also, a leading portion of each content may be stored in the flash memory 103 so that the user can select a desired content without waiting for the start-up of the HDD 101.

It is here assumed that the maximum start-up time of the HDD 101 is 13 sec, an analog broadcast content (standard definition) is recorded at a recording bit rate of 6 Mbps, and a digital terrestrial broadcast content (high definition) is recorded at a recording bit rate of 25 Mbps. In this case, quantitative effects of the present invention are estimated as follows.

Firstly, the amount of recorded data when an analog broadcast content is recorded for one hour, is 6 Mbps×3600 sec=21.6 Gb (giga bits). On the other hand, the amount of recorded data when a digital terrestrial broadcast content is recorded for one hour, is 25 Mbps×3600 sec=90.0 Gb. Therefore, even if the capacity of the flash memory 103 is assumed to be 100 Gb, then when each content is fully recorded in the flash memory 103, only five analog broadcast contents can be recorded or only one digital terrestrial broadcast content can be recorded.

On the other hand, when only a leading portion of each content that continues until the HDD 101 is started up is stored in the flash memory 103 as in this embodiment, the amount of data stored in the flash memory 103 is 6 Mbps×13 sec=78 Mb in the case of an analog broadcast and 25 Mbps×13 sec=325 Mb in the case of a digital terrestrial broadcast. Therefore, if it is assumed that the number of contents to be stored into the recording/reproduction apparatus is 50, that is practically sufficient, then even when all the contents are recorded in high definition, the capacity of the flash memory 103 needs to be only 325 Mb×50=16.25 Gb. In other words, an increase in system cost by adding the flash memory 103 to a conventional recording/reproduction apparatus can be suppressed to a minimum level.

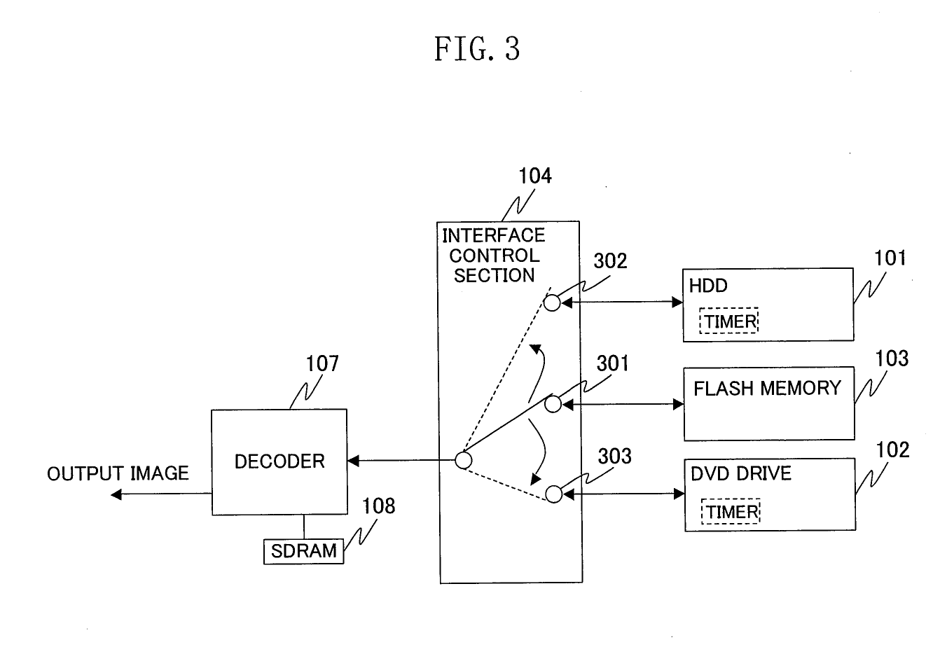

FIG. 3 shows switching of recording media in the reproduction step. A content is first reproduced from the flash memory 103 whose start-up time is considerably short (301). The reproduction of the content from the flash memory 103, when it is completed, is switched to reproduction from the HDD 101 or the DVD drive 102 that stores the main portion of the content, and a continuation of the content is then reproduced (302, 303). When content data (e.g., a content whose frequency of viewing is low, etc.) is not present in the flash memory 103, the content data is reproduced invariably and fixedly from the HDD 101 (302) or the DVD drive 102 (303) as in a conventional HDD recorder.

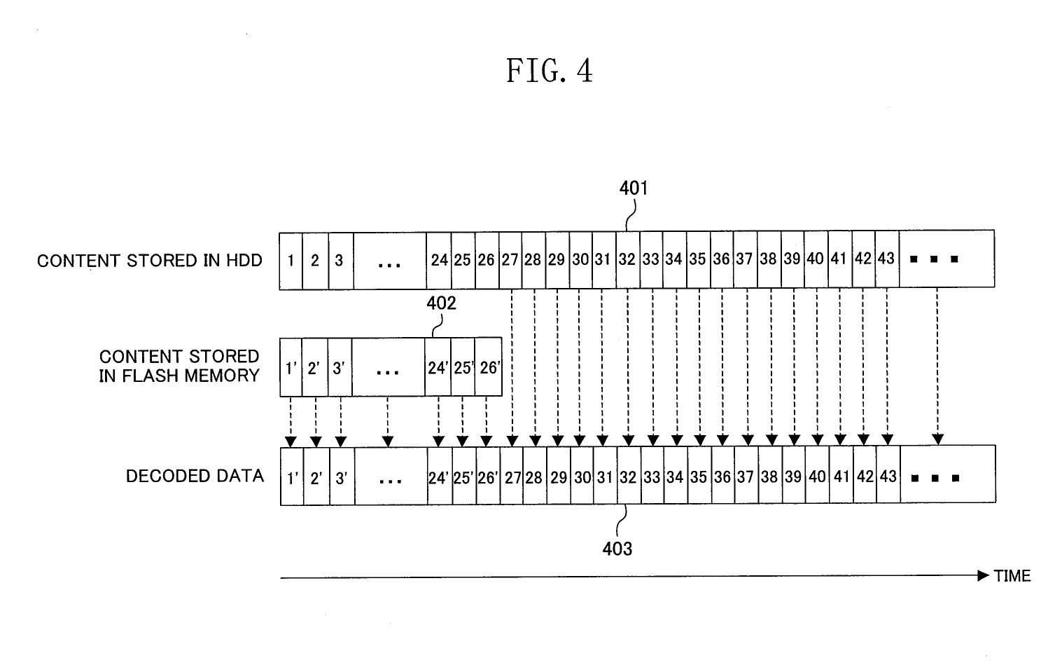

FIG. 4 schematically shows a stored state of a content in each recording medium during content reproduction in this embodiment. In FIG. 4, 401 schematically indicates content data stored in the HDD 101, 402 schematically indicates content data stored in the flash memory 103, and 403 schematically indicates, in a time series, buffering of a reproduction content to be decoded.

In FIG. 4, rectangles and numbers in the rectangles are units which constitute a content. Here, “1” in the HDD stored content 401 is a stream that is equivalent to “1′” in the flash memory stored content 402. Similarly, “2”, “3”, . . . , and “26” are streams that are equivalent to “2′”, “3′”, . . . , and “26′”, respectively. All pieces of the decoded data 403 are not simultaneously stored, and the stored data varies over time.

When a reproduction request is generated for a content, the leading portion 402 of the content stored in the flash memory 103, i.e., “1′”, “2′”, “3′”, . . . , and “25′”, “26′”, are successively supplied from the flash memory 103 to the decoder 107 as described above, so that they become “1′”, “′”, “3′?, . . . , and “25′”, “26′” in the decoded data 403.

When a content is being reproduced from the flash memory 103, the HDD 101 is not accessible, so that a stream cannot be reproduced from the HDD 101.

When the reproduction of the leading portion of a content from the flash memory 103 is completed, the HDD 101 has been completely started up, and a continuation of the data (i.e., “27” in the HDD stored content 401) is supplied to the decoder 107, so that it becomes “27” in the decoded data 403. Thereafter, the content data stored in the HDD 101, i.e., “28”, “29”, “30”, . . . , are reproduced.

Next, a case where a reproduction operation is started from a sleep state will be described. Here, the following situation is assumed. Specifically, when a content is being reproduced from the HDD 101, the reproduction is interrupted. In this case, the recording/reproduction apparatus starts outputting video from a tuner. In this case, the reproduction of the content from the HDD 101 is interrupted. In view of power consumption, the HDD 101 is desirably caused to be in the low-power mode, if possible. If a play button is here pressed again, a continuation of the content that the user has watched immediately before the HDD 101 was interrupted is desirably reproduced.

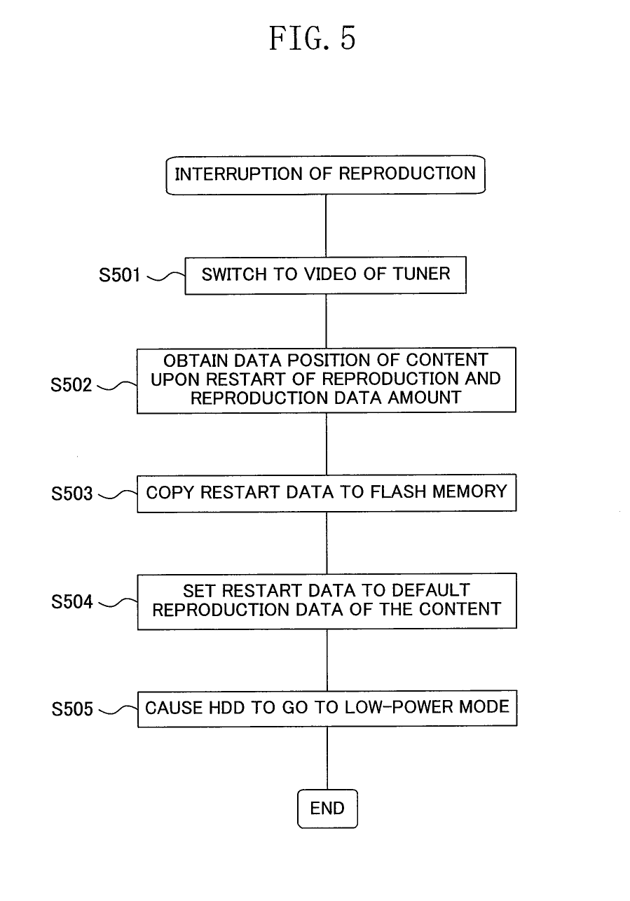

FIG. 5 is a flowchart when the HDD 101 is caused to go to the low-power mode in such a situation. In FIG. 5, when a stop button is pressed, switching of videos is performed (S501). In this case, content data that is required when reproduction is restarted is identified from time at which the decoder 107 was stopped, and the amount of reproduced data to be copied to the flash memory 103 is obtained (S502). The amount of data to be copied corresponds to a time that is required from when the HDD 101 in the low-power mode is powered ON to when the HDD 101 goes to the normal mode.

Next, the content data designated in step S502 is copied from the HDD 101 to the flash memory 103 (S503). The copied content data in this case is referred to as default reproduction data. Next, information about a data position of a continuation of the copied data is recorded into the flash memory 103 (S504). Finally, the HDD 101 is caused to be in the low-power mode (S505).

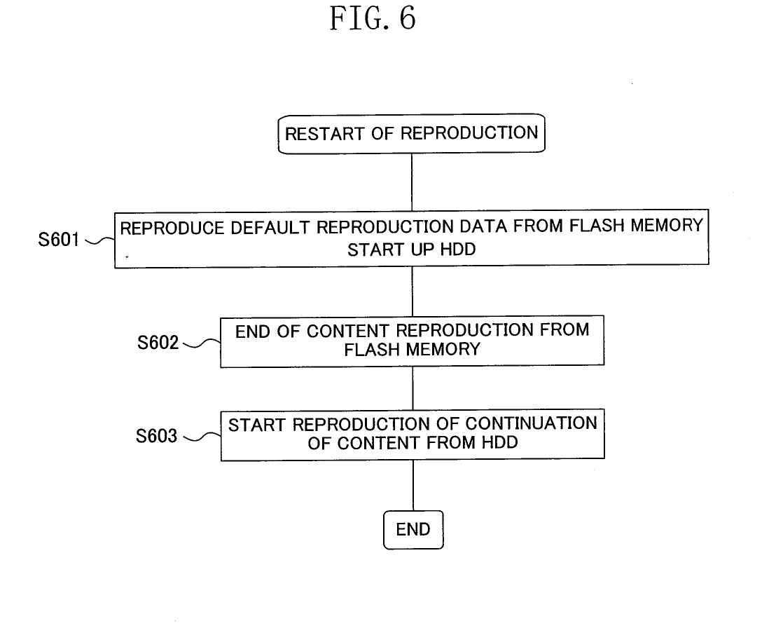

FIG. 6 shows an operation when the play button is pressed again after the HDD 101 goes to the low-power mode. When the play button is pressed, reproduction of the default reproduction data set in step S504 of FIG. 5 from the flash memory 103 is started, and at the same time, the HDD 101 is started up (S601). Note that, here, the operation for seamlessly switching the flash memory 103 and the HDD 101 shown in steps S204 to S207 of FIG. 2 is performed. When the reproduction of content data from the flash memory 103 is completed (S602), a data position of a continuation of the data is read in, and the continuation of the data is supplied to the decoder 107 (S603).

Thus, before a process having a low access rate to a medium (transition to the low-power mode) is performed, a portion of content data that is to be read out from the medium after restart is previously read into a memory that can be quickly started up (the flash memory 103 in this embodiment).

Thereby, even when content reproduction is restarted, the user can comfortably perform an operation without waiting for the start-up time of a medium. Also, power consumption can be suppressed by causing a medium having large power consumption to go to the low-power mode.

Finally, a case where video received from a tuner is received will be described, for example. Attention should be paid to the fact that each recorded content is frequently accessed at its recording start point. This is because a first video portion of each content is desirably presented on a menu that is first displayed when the user issues a reproduction request. Therefore, if a portion of a content that continues for a predetermined time or more from its recording start point is previously stored in both the HDD 101 and the flash memory 103 as described above, a desirable menu is displayed when a reproduction request is issued at the next time and thereafter. Also, an editing point, such as chapter information added when the user edits a content, may be recorded in the flash memory 103.

In addition, only intra-pictures of MPEG may be written into the flash memory 103, taking scene search into account. If such videos that can be used by the user for the purpose of content search are recorded in the flash memory 103, the HDD 101 can be completely started up while the user is performing scene search, so that the user substantially does not need to wait for the start-up of the HDD 101.

Thus, various examples have been described above. If a stream portion that is considered to have a high access frequency upon the start-up is arranged to be recorded into the flash memory 103, a significant effect is obtained. Only a portion of each content is desirably stored in the flash memory 103, while the whole content is stored in the HDD 101. If the capacity of the flash memory 103 is limited, a content having a more recent recording date or a content having a higher access frequency may be recorded in the flash memory 103 with higher priority.

The amount of each content may be reduced by compression. As described above, a leading portion of a content, a portion of a content immediately after reproduction is interrupted, data for content search, and the like are stored in the flash memory 103. In this case, the content data may not be necessarily recorded in the same format as that of data stored in the HDD 101 or the like. Particularly, for example, in the case of a DVD, data that is used in random access for navigation is regularly written onto the DVD in accordance with constraints on the standards. However, in the flash memory 103, data that conforms to the standards is not necessarily required since its time length is relatively short. Therefore, data excluding an unnecessary portion can be transferred to the flash memory 103. Also, content data itself may be recompressed in its own format or may be compressed again in a different format.

As described above, a content is recorded into two recording media, i.e., the HDD 101 and the flash memory 103. In view of security or the like, the content is desirably encrypted before being recorded into the flash memory 103.

Although a feature and an operation of this embodiment employing the HDD 101 have been described, the same is substantially true of the DVD drive 102.

As described above, according to this embodiment, two or more recording media having different start-up times that are required until data access is permitted are provided. One of the media is the HDD 101 that has a long time that is required until data access is permitted and has a large recording capacity, while the other is the flash memory 103 that has a short start-up time that is required until data access is permitted and has a small recording capacity. Content reproduction is invariably started from the flash memory 103 having a short start-up time, thereby making it possible to reduce a time that is required until start of reproduction.

In conventional HDD recorders, once the HDD 101 is caused to go to the low-power mode, the user has to wait for a while until the HDD 101 is started up upon the next reproduction. By contrast, in this embodiment, even if the HDD 101 is in the low-power mode, the flash memory 103 can be used to quickly respond to the user's reproduction request. Therefore, when access is not performed, the HDD 101 having large power consumption is caused to be in the low-power mode, thereby reducing power consumption, and further, the user does not have to wait for the start-up of the HDD 101 upon the next reproduction.

In particular, this embodiment is characterized in that only an amount of data corresponding to a time that is required until the HDD 101 can be accessed is recorded into the flash memory 103. Therefore, a plurality of contents can be efficiently recorded into the flash memory 103, so that the system cost of addition of the flash memory 103 can be suppressed to a low level.

As described above, the recording/reproduction apparatus of the present invention has two or more recording media with different start-up times that are required until data access is permitted, and performs reproduction while switching the recording media, thereby making it possible to reduce a time that is required until reproduction is permitted.

What is claimed is:

1. A recording/reproduction apparatus comprising:
a first recording medium having a first time that is required for the first recording medium to go from a low-power consumption state to a state in which recorded video data can be read out;
a second recording medium having a second time that is required for the second recording medium to go from a low-power consumption state to a state in which recorded video data can be read out, wherein the second time is longer than the first time; and
a reproduction control section for controlling the first and second recording media so that a recorded video content is reproduced,
wherein the reproduction control section, when a video content is reproduced from the second recording medium in the low-power consumption state, causes the first recording medium to go to a readable state while the second recording medium is not in a readable state, and causes the content to be reproduced from the first recording medium.

2. The recording/reproduction apparatus of claim 1, wherein
the reproduction control section, when a video content is reproduced from the second recording medium, causes the video content to be reproduced from the first recording medium until the second recording medium goes from the low-power consumption state to a state in which recorded video data can be read out, and after the second recording medium goes to the readable state, causes a continuation data of the video content reproduced from the first recording medium to be reproduced from the second recording medium.

3. The recording/reproduction apparatus of claim 1, wherein
a content is recorded in the first recording medium in association with information about a time for which the content can be reproduced from the first recording medium, and reproduction from the first recording medium is seamlessly switched to reproduction from the second recording medium based on the content reproduction time information and information about a time that is required for the second recording medium to go from the low-power consumption state to a state in which recorded video data can be read out from the second recording medium.

4. The recording/reproduction apparatus of claim 1, further comprising:
a timer for indicating a time lapse of a transition state of the second recording medium so as to obtain information about a time that is required for the second recording medium to go from the low-power consumption state to a state in which recorded video data can be read out from the second recording medium.

5. The recording/reproduction apparatus of claim 1, wherein
when the second recording medium is caused to go from the readable state to the low-power consumption state to a sleep state while a video content is being reproduced from the second recording medium, content data immediately after the reproduction from the second recording medium is interrupted or content data before and after the reproduction from the second recording medium is interrupted is copied to the first recording medium, and
when a request for restart of reproduction from the second recording medium is issued, the first recording medium is caused to go to the readable state until the second recording medium goes to the readable state, and the content data copied to the first recording medium is reproduced, and after the second recording medium goes to the readable state, a continuation data of the video content reproduced from the first recording medium is reproduced from the second recording medium.

6. The recording/reproduction apparatus of claim 1, further comprising:
a recording format converting section for removing information unnecessary for reproduction of a video content using the first recording medium, from a video content recorded in the second recording medium,
wherein the format-converted video content is recorded into the first recording medium, and the recorded video content is reproduced from the first recording medium.

7. The recording/reproduction apparatus of claim 1, wherein
the first recording medium is a non-volatile semiconductor memory.

8. The recording/reproduction apparatus of claim 1, wherein
the second recording medium is a magnetic disk medium, an optical disc medium, or a combination thereof.
